(19) United States
(12) Patent Application Publication
(10) Pub. No.: US 2021/0254371 A1
(43) Pub. Date: Aug. 19, 2021

(54) GOODS PROTECTION LABEL THAT MAY BE SECURED TO A PRODUCT

(71) Applicant: FOX GUARD IP PTY LTD, North Sydney (AU)

(72) Inventor: Balazs OLTVAI, Budapest (HU)

(21) Appl. No.: 17/308,566

(22) Filed: May 5, 2021

Related U.S. Application Data
(63) Continuation of application No. PCT/HU2019/000030, filed on Oct. 14, 2019.

(30) Foreign Application Priority Data
Nov. 5, 2018 (HU) P1800372

(51) Int. Cl. E05B 73/00

(52) U.S. Cl. CPC E05B 73/0047

(57) ABSTRACT

A goods protection label is provided, which contains a head part having an extendible fixing extension and a housing adapted for accommodating the extendible fixing extension. A clamping part for receiving a part of the fixing extension is located in the receiving space of the housing, the clamping part having a base body surrounding the holding space, and a holding piece partially protruding into the holding space of the base body and at least two moveable tensioner pieces fitted into the holding piece. The housing has an opening in the vicinity of the clamping part adapted for transferring the fixing extension. A returning element capable of flexibly changing shape is interposed between the holding piece and the housing, and with the returning element the holding piece or the tensioner pieces are forced in the direction of the opening located in the vicinity of the clamping part.

### CROSS-REFERENCE TO RELATED APPLICATIONS

This application is a continuation of International Patent Application No. PCT/HU2019/000030, filed Oct. 14, 2019, which claims priority from Hungarian Patent Application No. P1800372, filed Nov. 5, 2018, and these applications are incorporated herein by reference for all purposes as if fully set forth herein.

### FIELD OF THE INVENTION

The invention relates to a goods protection label that may be secured to a product, which contains a head part having an extendible fixing extension and a housing adapted for accommodating the extendible fixing extension of the head part, where a clamping part-unit for receiving at least a part of the fixing extension is located in the receiving space of the housing, the clamping part-unit has a base body surrounding the holding space, as well as a holding piece at least partially protruding into the holding space of the base body and at least two moveable tensioner pieces fitted into the holding piece, the housing has an opening in the vicinity of the clamping part-unit adapted for transferring the fixing extension, furthermore a returning element capable of flexibly changing shape is interposed between the holding piece and the housing, and with the returning element the holding piece and/or the tensioner pieces are forced in the direction of the opening located in the vicinity of the clamping part-unit, also the holding piece is coupled with a shifting part-unit, and the shifting part-unit is interposed between the holding piece and the housing adapted for removing the inner end of the holding piece supporting the tensioner pieces from the opening of the housing.

### BACKGROUND

Shop owners have been protecting against the theft of the products offered for sale in shops for a long time. Numerous goods protection devices with differing structures and operation principles operate more or less effectively. Even in the case of clothing and textile industry products goods protection labels have been developed that may be secured to the products to be protected so that these products do not suffer any permanent damage. The essence of these goods protection labels is that they consist of two parts that may be secured together. Among these the one has a needle-like protrusion, while there is a clamping device for clamping this needle-like protrusion and an activation piece switching on the alarm in the internal space of the other.

Several various solutions have been created for securing and releasing this needle-like protrusion. Such a solution may be found in patent specifications registration numbers U.S. Pat. Nos. 8,590,348 and 8,590,349, among others. In the case of both solutions a basket-like locking piece containing balls forms the structural unit for receiving the protrusion, in which the balls performing the actual locking are loosely located in a holding piece.

In the case of invention registration number U.S. Pat. No. 8,590,348 a rotatable mechanism consisting of several inclined toothed rings is used to release the lock, and when one of its elements is pressed it turns while shifting in the direction of the rotation axis and during this turning it turns another toothed ring in such a way so that it can shift the holding piece holding the balls in the direction of the axis of rotation and with this release the clamped needle-like connection protrusion.

In the case of the solution appearing in patent specification registration number U.S. Pat. No. 8,590,349, a shaped structural unit is used to shift the holding piece holding the balls that consists of two rings with different external and internal diameters and several curved ribbons connecting these. In the case the outer ring is pressed the inner ring moves in a direction opposite to the direction of pressing and so shifts the holding piece holding the balls in the direction opposite to the direction or pressing thereby releasing the clamped needle-like connection protrusion.

The advantage of both solutions is that the shifting of the holding piece holding the balls takes place indirectly with an intermediate element that itself is protected against sabotage.

However, the greatest disadvantage of these solutions is that among the structural elements shifting the holding piece holding the balls, the “activation” of the external structural element in contact with the unlocking structure is relatively simple, the external shifting element may be easily accessed, and the turning of the given structural element may be implemented with an unlocking device that could even be made at home, and so the goods protection label may be simply removed from the protected product, in other words the goods protection label does not perform its task.

Another significant disadvantage is that the operation of the structural elements performing the releasing of the needle-like protrusion is difficult, because of the friction and/or shape change related to the shifting, deformation, getting stuck and breakage may easily occur, therefore the permitted unlocking carried out at the checkout when the goods are handed over cannot be so reliably realised, which causes an unnecessary waste of time for both the customer and the cashier too.

Another feature that must be treated as a disadvantage is that due to the shape and use of the structural elements participating in the unlocking their lifetime is relatively short, which may further impair the reliable operation of the solution.

Another disadvantage is that several structural elements are required for the unlocking, which does not only increase the production cost of the goods protection label, but because of the wear resulting from the friction this fact further reduces the lifetime and also increases the probability of faults occurring.

The objective with the arrangement according to the invention was to overcome deficiencies of the known goods protection labels consisting of two parts that may be connected with a needle-like protrusion that make operation and reliable use difficult, and to create a version in the case of which the holding piece holding the balls, which is known of in itself and used widely, can be shifted with a single moving component in such a way that during shifting it does not get stuck or become broken, and the wear resulting from the friction of the moving component does not lead to the uncertain operation of the goods protection label, furthermore, in the case of which the activation of the moving piece of the shifting part-unit can only be realised with a dedicated unlocking device, and so the removal of the goods protection label may also be suitably reliable.

The recognition that led to the solution according to the invention was that if a wedge path is used to release the locking caused by the holding piece holding the balls that is unconventionally formed, on the one part, on the internal surface of the housing, and, on the other part, on a moving piece moving the holding piece holding the balls, and the moving piece is fitted into the housing in a novel way, and is forced to move in a unique way, then by using a single moving element the holding piece holding the balls may only be moved with a unique unlocking device in the direction of the longitudinal axis of the needle-like protrusion reliably, without the risk of it getting stuck or of sabotage occurring, and so the task can be solved. The idea behind the invention also included that if the single moving piece moving the holding piece holding the balls is locked to the housing in a way completely different to those known of, and if the locking and the moving of the holding piece holding the balls is carried out in a given order, from a given direction with the same unlocking device, the even more reliable sabotage protection can be achieved, and so the task can be solved with an even more favourable result.

### SUMMARY

In accordance with the set objective the goods protection label that may be secured to a product according to the invention,—which contains a head part having an extendible fixing extension and a housing adapted for accommodating the extendible fixing extension of the head part, where a clamping part-unit for receiving at least a part of the fixing extension is located in the receiving space of the housing, the clamping part-unit has a base body surrounding the holding space, as well as a holding piece at least partially protruding into the holding space of the base body and at least two moveable tensioner pieces fitted into the holding piece, the housing has an opening in the vicinity of the clamping part-unit adapted for transferring the fixing extension, furthermore a returning element capable of flexibly changing shape is interposed between the holding piece and the housing, and with the returning element the holding piece and/or the tensioner pieces are forced in the direction of the opening located in the vicinity of the clamping part-unit, also the holding piece is coupled with a shifting part-unit, and the shifting part-unit is interposed between the holding piece and the housing adapted for removing the inner end of the holding piece supporting the tensioner pieces from the opening of the housing,—is set up in such a way that the shifting part-unit has a moving piece having a first sliding surface and a second sliding surface, the housing has a stationary supporting surface in contact with the first sliding surface of the moving piece, while the holding piece has a moving supporting surface in contact with the second sliding surface of the moving piece, where the first sliding surface and the stationary supporting surface and/or the second sliding surface and the moving supporting surface are formed by screw thread paths cooperating with each other located along a helix at least partially running around the rotation axis of the shifting part-unit, and the moving piece of the shifting part-unit is interposed between the stationary supporting surface of the housing and the moving supporting surface of the holding piece in such a way that it may rotate around the rotation axis of the shifting part-unit, and the moving piece of the shifting part-unit is provided with a movement receipt body that may be connected to a propulsion device.

A further feature of the goods protection label according to the invention may be that the first sliding surface and the stationary supporting surface and/or the second sliding surface and the moving supporting surface are screw thread paths cooperating with each other forming a saw tooth-like multi-start rising inclined track at least partially running around the rotation axis of the shifting part-unit.

According to the set objective the second goods protection label that may be secured to a product according to the invention,—which contains a head part having an extendible fixing extension and a housing adapted for accommodating the extendible fixing extension of the head part, where a clamping part-unit for receiving at least a part of the fixing extension is located in the receiving space of the housing, the clamping part-unit has a base body surrounding the holding space, as well as a holding piece at least partially protruding into the holding space of the base body and at least two moveable tensioner pieces fitted into the holding piece, the housing has an opening in the vicinity of the clamping part-unit adapted for transferring the fixing extension, furthermore a returning element capable of flexibly changing shape is interposed between the holding piece and the housing, and with the returning element the holding piece and/or the tensioner pieces are forced in the direction of the opening located in the vicinity of the clamping part-unit, also the holding piece is coupled with a shifting part-unit, and the shifting part-unit is interposed between the holding piece and the housing adapted for removing the inner end of the holding piece supporting the tensioner pieces from the opening of the housing,—is set up in such a way that the shifting part-unit has a moving piece having a sliding surface, while the housing has a stationary supporting surface in contact with the sliding surface of the moving piece, where the sliding surface and the stationary supporting surface are formed by screw thread paths cooperating with each other located along a helix at least partially running around the rotation axis of the shifting part-unit, and the moving piece of the shifting part-unit is interposed between the stationary supporting surface of the housing and the external end of the holding piece in such a way that it may rotate around the rotation axis of the shifting part-unit, and the moving piece of the shifting part-unit is provided with a movement receipt body that may be connected to a propulsion device.

A further feature of this second goods protection label according to the invention may be that the holding piece of the clamping part-unit and the moving piece of the shifting part-unit are from a single piece, and the sliding surface is formed on the side of the moving piece formed as an encircling collar at the external end of the holding piece facing the base body of the clamping part-unit.

In the case of another version of the goods protection label the sliding surface and the stationary supporting surface are screw thread paths cooperating with each other forming a saw tooth-like multi-start rising inclined track at least partially running around the rotation axis of the shifting part-unit.

According to the set objective a further goods protection label that may be secured to a product according to the invention,—which contains a head part having an extendible fixing extension and a housing adapted for accommodating the extendible fixing extension of the head part, where a clamping part-unit for receiving at least a part of the fixing extension is located in the receiving space of the housing, the clamping part-unit has a base body surrounding the holding space, as well as a holding piece at least partially protruding into the holding space of the base body and at least two moveable tensioner pieces fitted into the holding piece, the housing has an opening in the vicinity of the clamping part-unit adapted for transferring the fixing extension, furthermore a returning element capable of flexibly changing shape is interposed between the holding piece and the housing, and with the returning element the holding piece and/or the tensioner pieces are forced in the direction of the opening located in the vicinity of the clamping part-unit, also the holding piece is coupled with a shifting part-unit, and the shifting part-unit is interposed between the holding piece and the housing adapted for removing the inner end of the holding piece supporting the tensioner pieces from the opening of the housing,—is set up in such a way that the shifting part-unit has a moving piece having a first sliding surface and a second sliding surface, the housing has a stationary supporting surface in contact with the first sliding surface of the moving piece, while the holding piece has a moving supporting surface in contact with the second sliding surface of the moving piece, where the first sliding surface and the stationary supporting surface and/or the second sliding surface and the moving supporting surface are formed by wedge path strips located in a plane at an acute angle of inclination to the longitudinal main axis of the shifting part-unit, and the moving piece of the shifting part-unit is interposed between the stationary supporting surface of the housing and the moving supporting surface of the holding piece in such a way that it may slide in a sliding direction at an angle of 60-120° to the longitudinal main axis of the shifting part-unit, and the moving piece of the shifting part-unit is provided with a movement receipt body that may be connected to a propulsion device.

In the case of another version of the goods protection label the housing is provided with a first bolt-accommodating cavity, while the moving piece of the shifting part-unit is provided with a second bolt-accommodating cavity, and the first bolt-accommodating cavity and the second bolt-accommodating cavity are coupled with the bolt bodies cooperating with them, where the bolt body is fitted into the first bolt-accommodating cavity of the housing with the interposition of a return piece so as to protrude from it but is capable of being moved back into it, and the movement axis of the bolt body is at an tilt angle of 0-90° to the longitudinal axis of the base body.

From the point of view of the invention it may be preferable if the base body is made from the material of the housing, and forms a single unit with it. Optionally, an insert made from a metal material is inserted into the holding space of the base body, and the holding piece of the clamping part-unit is at least partially inserted into the insert. The insert is also provided with a guide passage adapted for transferring the fixing extension, and the guide passage of the insert is located in the vicinity of the opening of the housing.

In the case of yet another different embodiment of the goods protection label the tensioner pieces are identically sized spheres. While the return piece is an energy-storing piece, such as a coil spring, inserted into the first bolt-accommodating cavity of the housing. Furthermore, the returning element is a coil spring.

The goods protection label according to the invention has numerous preferable characteristics, including that as a result of the unique structure of the wedge path and its novel location, and the position and method of operation of the moving piece consisting of a single element, the holding piece may be simply rotated around the rotation axis of the shifting part-unit without getting stuck or obstructed, or shifted along a straight-lined track that intersects the longitudinal axis of the base body, and so operation reliability is better than that of the known solutions.

According to the set objective, there is provided a further goods protection label that is able to be secured to a product, the goods protection label including:
A head part having an extendible fixing extension, a housing adapted for accommodating the extendible fixing extension of the head part, and a clamping part-unit for receiving at least a part of the fixing extension, the clamping part-unit having a holding piece and at least two moveable tensioner pieces fitted into the holding piece, where:
The housing has an opening in the vicinity of the clamping part-unit adapted for transferring the fixing extension, a returning element is interposed between the holding piece and the housing, the returning element being configured to force the holding piece and/or two or more tensioner pieces of the clamping-part unit in the direction of the opening located in the vicinity of the clamping part-unit, and the holding piece is coupled with a shifting part-unit, and the shifting part-unit includes a moving piece, characterised in that:
The moving piece is able to rotate around a rotation axis of the shifting part-unit, the goods protection label includes a movement-preventing structural part to prevent rotation of the moving piece, the movement-preventing structural part able to be unlocked by use of an unlocking device, the moving piece of the shifting part-unit is provided with a movement receipt body that is connectable to a propulsion device for applying torque to the movement receipt body to rotate the moving piece, and the head part of the goods protection label is able to be removed from the housing by:
Using the unlocking device to unlock the movement-preventing structural part to permit movement of the moving piece, and then using the propulsion device to rotate the moving piece.

A further feature of the goods protection label is that the head part of the goods protection label may be able to be removed from the housing by a single structural unit including the propulsion device and the unlocking device.

A further feature of the goods protection label is that the goods protection label may be connectable to the propulsion device and the unlocking device for removing the head part of goods protection label from the housing, and after the fixing extension of the head part has been removed, the goods protection label may be removable from the propulsion device and the unlocking device.

A further feature of the goods protection label is that rotation of the moving piece about the rotation axis may compress the returning element interposed between the housing and the moving piece.

A further feature of the goods protection label is that after termination of the torque exerted onto the movement receipt body during unlocking, strain energy accumulated in the returning element may push the holding piece back into a basic position.

A further feature of the goods protection label is that the movement preventing-structural part may include a first cavity in the housing and movement of the moving piece may be allowed when the movement-preventing body occupies the first cavity.

A further feature of the goods protection label is that the movement-preventing structural part may include a movement-preventing body and a second cavity in the shifting part-unit, such that movement of the moving piece is prevented when the movement-preventing body occupies the second cavity. A part of the movement-preventing body may be configured to be able to be withdrawn from the second cavity of the shifting part-unit and to occupy the first cavity of the housing during unlocking, permitting the moving piece of the shifting part-unit to be rotatable around the rotation axis.

The movement-preventing body may be moveable in the direction of a movement axis by the unlocking device. The movement-preventing structural part may include a return piece interposed between the movement-preventing body and the housing. The movement-preventing body may be configured to be moved against the return piece along the movement axis during unlocking of the movement-preventing structural part. The movement axis of the movement-preventing body may be at a tilt angle to the rotation axis of the moving piece of the shifting part-unit having a value between 0-90°, including 0° and 90°.

A further feature of the goods protection label is that the shifting part-unit may be interposed between the holding piece and the housing, and adapted for removing an internal end of the holding piece supporting the tensioner pieces from the opening of the housing.

A further feature of the goods protection label is that the moving piece may have a first sliding surface and a second sliding surface, and the housing may have a stationary supporting surface in contact with the first sliding surface of the moving piece, while the holding piece may have a moving supporting surface in contact with the second sliding surface of the moving piece. The first sliding surface and the stationary supporting surface and/or the second sliding surface and the moving supporting surface may cooperate with each other to provide rotation of the moving piece around the rotation axis of the shifting part-unit. The clamping part-unit may include a base body surrounding a holding space and the holding piece may at least partially protrude into the holding space of the base body. The moving piece of the shifting part-unit may be interposed between the stationary supporting surface of the housing and the moving supporting surface of the holding piece in such a way that it is able to rotate around the rotation axis of the shifting part-unit.

Rotation of the moving piece about the rotation axis may lift up the holding piece and/or tensioner pieces from the opening of the housing. When the tensioner pieces are lifted up they may get to an increasingly larger cross-section part of a conical shell shaped surface delimiting the holding space and/or the holding piece, and in this way a tensioning effect on the fixing extension derived from the conical surface weakens, and then ceases to exist, as the tensioner pieces have sufficient space to move away from the fixing extension. Lifting up the holding piece and/or tensioner pieces may enable the fixing extension to be removed through the opening of the housing from among the released tensioner pieces from the holding space enclosed by the base body of the housing.

A further feature of the goods protection label is that the first sliding surface of the moving piece may slide perpendicular to a longitudinal axis on the stationary supporting surface of the base body. The rotation axis of the shifting part-unit may be perpendicular to the longitudinal axis of the base body. The torque transferred by the propulsion device to the movement receipt body may induce the moving piece of the shifting part-unit to rotate in such a way that it rotates around the longitudinal axis of the base body and simultaneously around the rotation axis of the shifting part-unit.

A further feature of the goods protection label is that the head part may be removable from the housing by using a propulsion device that is separate from or independent of the unlocking device.

According to the set objective, there is provided a further goods protection label that is able to be secured to a product, the goods protection label including:
A head part having an extendible fixing extension, a housing adapted for accommodating the extendible fixing extension of the head part, and a clamping part-unit for receiving at least a part of the fixing extension is located in a receiving space of the housing, the clamping part-unit having a base body surrounding a holding space, as well as a holding piece at least partially protruding into the holding space of the base body and at least two moveable tensioner pieces fitted into the holding piece, where:
The housing has an opening in the vicinity of the clamping part-unit adapted for transferring the fixing extension, a returning element capable of flexibly changing shape is interposed between the holding piece and the housing, the returning element being configured to force the holding piece and/or the tensioner pieces in the direction of the opening located in the vicinity of the clamping part-unit, the holding piece is coupled with a shifting part-unit, and the shifting part-unit is interposed between the holding piece and the housing adapted for removing an internal end of the holding piece supporting the tensioner pieces from the opening of the housing, the shifting part-unit has a moving piece, the moving piece has a first sliding surface and a second sliding surface, the housing has a stationary supporting surface in contact with the first sliding surface of the moving piece, and the holding piece has a moving supporting surface in contact with the second sliding surface of the moving piece, where the first sliding surface and the stationary supporting surface and/or the second sliding surface and the moving supporting surface cooperate with each other to provide rotation of the moving piece around a rotation axis of the shifting part-unit, and the moving piece of the shifting part-unit is interposed between the stationary supporting surface of the housing and the moving supporting surface of the holding piece in such a way that it is able to rotate around the rotation axis of the shifting part-unit, characterised in that:
The goods protection label includes a movement-preventing structural part to prevent rotation of the moving piece, the movement-preventing structural part able to be unlocked by use of an unlocking device, the moving piece of the shifting part-unit is provided with a movement receipt body that is connectable to a propulsion device for applying torque to the movement receipt body to rotate the moving piece, and the head part of the goods protection label is able to be removed from the housing by:
Use of the unlocking device to release the movement-preventing structural part to permit movement of the moving piece, and then use of the propulsion device to rotate the moving piece.

A further feature of the goods protection label is that the first sliding surface and the stationary supporting surface and/or the second sliding surface and the moving supporting surface are formed by screw thread paths cooperating with each other located along a helix at least partially running around the rotation axis of the shifting part-unit. The first sliding surface and the stationary supporting surface and/or the second sliding surface and the moving supporting surface may be screw thread paths cooperating with each other forming a saw tooth-like multi-start rising inclined track at least partially running around the rotation axis of the shifting part-unit.

According to the set objective, there is provided a further goods protection label that is able to be secured to a product, the goods protection label including:
A head part having an extendible fixing extension, a housing adapted for accommodating the extendible fixing extension of the head part, and a clamping part-unit for receiving at least a part of the fixing extension, the clamping part-unit being located in a receiving space of the housing, the clamping part-unit having a base body surrounding a holding space, as well as holding piece at least partially protruding into the holding space of the base body and at least two moveable tensioner pieces fitted into the holding piece, where:
The housing has an opening in the vicinity of the clamping part-unit adapted for transferring the fixing extension, a returning element capable of flexibly changing shape is interposed between the holding piece and the housing, the returning element being configured to force the holding piece and/or the tensioner piece in the direction of the opening located in the vicinity of the clamping part-unit, the holding piece is coupled with a shifting part-unit, and the shifting part-unit is interposed between the holding piece and the housing adapted for removing an internal end of the holding piece supporting the tensioner pieces from the opening of the housing, the shifting part-unit has a moving piece that it is able to rotate around the rotation axis of the shifting part-unit, characterised in that:
the goods protection label includes a movement-preventing structural part to prevent rotation of the moving piece, the movement-preventing structural part able to be unlocked by use of an unlocking device, the moving piece of the shifting part-unit is provided with a movement receipt body that is able to be connected to a propulsion device for applying torque to the movement receipt body to rotate the moving piece; and the head part of the goods protection label is able to be removed from the housing by:
use of the unlocking device to release the movement-preventing structural part to permit movement of the moving piece, and then use of the propulsion device to rotate the moving piece.

A further feature of the goods protection label is that the moving piece may have a sliding surface, the housing may have a stationary supporting surface in contact with the sliding surface of the moving piece.

A further feature of the goods protection label is that the sliding surface and the stationary supporting surface may be formed by screw thread paths cooperating with each other located along a helix at least partially running around a rotation axis of the shifting part-unit.

A further feature of the goods protection label is that the moving piece of the shifting part-unit may be interposed between the stationary supporting surface of the housing and an external end of the holding piece in such a way that it is able to rotate around the rotation axis of the shifting part-unit.

A further feature of the goods protection label is that the holding piece of the clamping part-unit and the moving piece of the shifting part-unit may be from a single piece, and the sliding surface may be formed on the side of the moving piece formed as an encircling collar at the external end of the holding piece facing the base body of the clamping part-unit.

The sliding surface and the stationary supporting surface may be screw thread paths cooperating with each other forming a saw tooth-like multi-start rising inclined track at least partially running around the rotation axis of the shifting part-unit.

According to the set objective, there is provided a further goods protection label that is able to be secured to a product, the goods protection label including:
A head part having an extendible fixing extension, a housing adapted for accommodating the extendible fixing extension of the head part, and a clamping part-unit for receiving at least a part of the fixing extension is located in a receiving space of the housing, the clamping part-unit having a base body surrounding a holding space, as well as a holding piece at least partially protruding into the holding space of the base body and at least two moveable tensioner pieces fitted into the holding piece, where:
The housing has an opening in the vicinity of the clamping part-unit adapted for transferring the fixing extension, a returning element capable of flexibly changing shape is interposed between the holding piece and the housing, the returning element being configured to force the holding piece and/or the tensioner pieces in the direction of the opening located in the vicinity of the clamping part-unit, the holding piece is coupled with a shifting part-unit, and the shifting part-unit is interposed between the holding piece and the housing adapted for removing an internal end of the holding piece supporting the tensioner pieces from the opening of the housing, the shifting part-unit has a moving piece, the moving piece is able to slide in a sliding direction, characterised in that:
the goods protection label includes a movement-preventing structural part to prevent movement of the moving piece, the movement-preventing structural part able to be unlocked by use of an unlocking device, the moving piece of the shifting part-unit is provided with a movement receipt body that is able to be connected to a propulsion device for sliding the moving piece in the sliding direction, and the head part of the goods protection label is able to be removed from the housing by:
use of the unlocking device to release the movement-preventing structural part to permit movement of the moving piece, and then use of the propulsion device to slide the moving piece.

A further feature of the goods protection label is that the moving piece may have a first sliding surface and a second sliding surface.

A further feature of the goods protection label is that the housing may have a stationary supporting surface in contact with the first sliding surface of the moving piece.

A further feature of the goods protection label is that the holding piece may have a moving supporting surface in contact with the second sliding surface of the moving piece.

A further feature of the goods protection label is that the first sliding surface and the stationary supporting surface and/or the second sliding surface and the moving supporting surface may be formed by wedge path strips located in a plane at an acute angle of inclination to a longitudinal main axis of the shifting part-unit.

A further feature of the goods protection label is that the moving piece of the shifting part-unit may be interposed between the stationary supporting surface of the housing and the moving supporting surface of the holding piece in such a way that it able to slide in the sliding direction.

A further feature of the goods protection label is that the sliding direction may be at an angle of 60-120° to the longitudinal main axis of the shifting part-unit.

A further feature of the goods protection label is that the housing may be provided with a first bolt-accommodating cavity, while the moving piece of the shifting part-unit may be provided with a second bolt-accommodating cavity, and the first bolt-accommodating cavity and the second bolt-accommodating cavity may be coupled with the bolt bodies cooperating with them, where the bolt body may be fitted into the first bolt-accommodating cavity of the housing with the interposition of a return piece so as to protrude from it but may be capable of being moved back into it, and the movement axis of the bolt body may be at an tilt angle of 0-90° to the longitudinal axis of the base body. The return piece may be an energy-storing piece inserted into the first bolt-accommodating cavity of the housing.

A further feature of the goods protection label is that the base body may be made from the material of the housing, and forms a single unit with it.

A further feature of the goods protection label is that an insert made from a metal material may be inserted into the holding space of the base body, and the holding piece of the clamping part-unit may be at least partially inserted into the insert.

A further feature of the goods protection label is that the insert may also be provided with a guide passage adapted for transferring the fixing extension, and the guide passage of the insert may be located in the vicinity of the opening of the housing.

A further feature of the goods protection label is that the tensioner pieces may be identically sized spheres.

A further feature of the goods protection label is that the returning element may be a coil spring.

According to the set objective, there is provided a further goods protection label that is able to be secured to a product, the goods protection label including: a head part having an extendible fixing extension, a housing adapted for accommodating the extendible fixing extension of the head part, and a clamping part-unit for receiving at least a part of the fixing extension, the clamping part-unit having a holding piece and at least two moveable tensioner pieces fitted into the holding piece, where: the housing has an opening in the vicinity of the clamping part-unit adapted for transferring the fixing extension, a returning element is interposed between the holding piece and the housing, the returning element being configured to force the holding piece and/or two or more tensioner pieces of the clamping-part unit in the direction of the opening located in the vicinity of the clamping part-unit, and the holding piece is coupled with a shifting part-unit, and the shifting part-unit includes a moving piece, characterised in that: the moving piece is able to rotate around a rotation axis of the shifting part-unit and/or slide in a sliding direction, the moving piece of the shifting part-unit is provided with a movement receipt body that is connectable to a propulsion device for applying force (e.g. torque) to the movement receipt body to rotate and/or slide the moving piece, and the head part of the goods protection label is able to be removed from the housing by: using an unlocking device to permit movement of the moving piece, and then using the propulsion device to rotate and/or slide the moving piece.

The features described in relation to one or more of the goods protection labels of the invention are to be understood as applicable to other goods protection labels of the invention. More generally, combinations of the features of the goods protection label of the invention described elsewhere in this specification, including in the claims, are to be understood as falling within the scope of the disclosure of this specification.

The goods protection label according to the invention has many preferable features. One advantage is that due to the small amount of friction between the moving piece and the stationary structural elements, the wear deriving from the friction does not influence operation reliability, which further reduces the probability of the goods protection label becoming faulty, and increases its lifetime.

It must also be treated as an advantage that the structural elements of the goods protection label are simple to manufacture and easy to assemble, but unauthorised opening cannot be achieved with a device someone makes at home, only with a special opening device.

It is important to highlight the favourable feature that in the case of the appropriate prevention of the sliding of the moving piece, i.e. in the case of the installation of suitably formed locking, unlocking or opening can only be provided in the case of release carried out in several movement directions in the correct order, which makes it possible to make the goods protection even more secure.

### BRIEF DESCRIPTION OF THE DRAWINGS

In the following the goods protection label according to the invention is described in detail by way of embodiments with reference to figures, wherein

FIG. 1 depicts a side view of a possible version of the goods protection label according to the invention, in cross-section,

FIG. 2 depicts a side view of another version of the goods protection label according to the invention, in cross-section,

FIG. 3 depicts a side view of yet another different embodiment of the goods protection label according to the invention, in cross-section,

FIG. 4 depicts a side view of a further embodiment of the goods protection label according to the invention, in cross-section.

### DETAILED DESCRIPTION OF THE PREFERRED EMBODIMENTS

FIG. 1 shows a possible version of the goods protection label according to the invention that is adapted for protecting clothing products against theft. The head part 10 having a needle-like fixing extension 11 known of in itself, and the housing 20 accommodating the fixing extension 11 of the head part 10 may be observed.

The clamping part-unit 30 responsible for holding the fixing extension 11 is located in the receiving space 21 of the housing 20, which contains the base body 31 delimiting the holding space 32 for receiving the holding piece 33, and the tensioner pieces 34 loosely accommodated in the holding piece 33, near to the internal end 33a of the holding piece 33. The tensioner pieces 34 here are steel balls, while the holding piece 33 and the housing 20 are made from plastic, preferably by injection moulding. The holding space 32 accommodating the tensioner pieces 34 is enclosed by a conical shell shaped surface in the interest of the appropriate operation, known of in itself, of the clamping part-unit 30.

An opening 22 falling in the longitudinal axis 31a of the base body 31 is established in the wall of the housing 20 delimiting the holding space 32 enclosed by the base body 31. The fixing extension 11 of the head part 10 gets through this opening 22 into the holding space 32 of the receiving space 21 of the housing 20 delimited by the base body, where the tensioning pieces 34 are located.

FIG. 1 also illustrates that the returning element 40 is located at the external end 33b of the holding piece 33 opposite the internal end 33a, which in this case is a coil spring and has the task of forcing the holding piece 33 holding the tensioning pieces 34 towards the opening 22 of the housing 20.

The encircling collar 33c may be found at the external end 33b of the holding piece 33 opposite the internal end 33a, which has a moving supporting surface 33d facing towards the internal end 33a. The stationary supporting surface 23 formed on the base body 31 of the housing 20 is located opposite this moving supporting surface 33d. The moving piece 51 of the shifting part-unit 50 is inserted between the moving supporting surface 33d of the holding piece 33 and the stationary supporting surface 23 of the housing 20. The moving piece 51 has a first sliding surface 51a and a second sliding surface 51b. The first sliding surface 51a is in contact with the stationary sliding surface 23 of the housing 20, while the second sliding surface 51b is in contact with the moving supporting surface 33d of the holding piece 33.

In the case of the given embodiment the second sliding surface 51b of the moving piece 51 and the moving supporting surface 33d of the holding piece 33 are circular rings each positioned in a plane “S”, which planes “S” are perpendicular to the longitudinal axis 31ₐ of the base body 31. The first sliding surface 51a of the moving piece 51 and the stationary supporting surface 23 of the housing 20 constitute a screw thread path that runs around the longitudinal axis 31a of the base body 31 in helix shape with a given pitch.

It is clearly visible in FIG. 1 that the rotation axis 52 of the moving piece 51 of the shifting part-unit 50 is coaxial with the longitudinal axis 31a of the base body 31. In this way while the moving piece 51 rotates around the rotation axis 52, on the one hand, the first sliding surface 51a is able to constantly cooperate with the stationary supporting surface 23, and, on the other hand, the second sliding surface 51b is able to constantly cooperate with the moving supporting surface 33d, the first sliding surface 51a and the second sliding surface 51b are able to slide on the stationary supporting surface 23 and on the moving supporting surface 33d without obstruction and without getting stuck.

It may also be observed in FIG. 1 that the shifting part-unit 50, in addition to the moving piece 51, has a movement receipt body 53 and a second bolt-accommodating cavity 54 as well. The task of the movement receipt body 53 is after coming into contact with the propulsion device 1, only shown in outline in FIG. 1, to transmit the movement passed on from that to the moving piece 51 of the shifting part-unit 50, and so turn that round the rotation axis 52.

The task of the second bolt-accommodating cavity 54 is to periodically provide space for a part of the bolt body 3. The other part of the bolt body 3 is permanently located in the first bolt-accommodating cavity 24 of the housing 20. The return piece 4 may be found in the first bolt-accommodating cavity 24 between the bolt body 3 and the wall of the housing 20, which here is an energy-storage piece 4a, preferably a coil spring. The task of the return piece 4 is in basic position to push out a part of the bolt body 3 from the first bolt-accommodating cavity 24 in the direction of the second bolt-accommodating cavity 54 of the shifting part-unit 50, but if necessary to make it possible for the bolt body 3 to be withdrawn to its entire extent into the first bolt-accommodating cavity 24. As a consequence of this the return piece 4 may be any structural element that fulfils this requirement.

It may also be seen that with the shifting part-unit 50 in its basic position, which is the state presented in FIG. 1, one part of the bolt body 3 occupies the first bolt-accommodating cavity 24, while its other part occupies the second bolt-accommodating cavity, and therefore in the given state also fixes the moving piece 51 of the shifting part-unit 50. The first bolt-accommodating cavity 24 and the second bolt-accommodating cavity 52 are formed so that the movement axis 3a of the bolt body 3 located in them is at an tilt angle “a” of 0-90°, here 15° to the longitudinal axis 31a of the base body 31 and, along with this, to the rotation axis 52 of the shifting part-unit 50.

The bolt body 3 occupies the first bolt-accommodating cavity 24 and the second bolt-accommodating cavity 54 so that it can be moved in the direction of the movement axis 3 a by the unlocking device 2. By using the unlocking device 2 the part of the bolt body 3 occupying the second bolt-accommodating cavity 54 of the shifting part-unit 50 may be withdrawn, and so the moving piece 51 of the shifting part-unit 50 may be made rotatable around the rotation axis 52.

It should be noted here that the propulsion device 1 and the unlocking device 2 may form a single structural unit, but they may also be two independent devices. The requirement of the propulsion device 1 and the unlocking device 2 is only that by using them the bolt body 3 and/or the moving piece 51 of the shifting part-unit 50 can be moved. Therefore, as the invention itself relates to a goods protection label the propulsion device 1 and the unlocking device 2 are not disclosed in more detail.

The operation of the goods protection label according to FIG. 1 is as follows. In the course of securing the goods protection label first of all the fixing extension 11 of the head part 10 has to be pierced through the clothing product to be protected, then the fixing extension 11 must be pushed into the opening 22 of the housing 20. The fixing extension 11 passing through the opening 22, in a way known of in itself, meets the tensioner pieces 34 located in the holding piece 33 and pushes them against the returning element 40 towards the centre of the receiving space 21 of the housing 20. Meanwhile the fixing extension 11 penetrates between the tensioner pieces 34 and by pushing them away from each other also forces them in the direction of the conical shell shaped internal surface of the base body 31. In the case that the movement of the fixing extension 11 towards the receiving space 21 of the housing 20 in the direction of the longitudinal axis 31a of the base body 31 ceases, then the returning element 40 forces the holding piece 33, and so the tensioner pieces 34 backwards, in the direction of the opening 22 of the housing 20.

In this way, however, the tensioner pieces 34 are forced up against the conical shell shaped internal surface of the base body 31 and up against the fixing extension 11. If now someone wants to pull the fixing extension 11 out of the opening 22 of the housing 20, then the friction force between the tensioner pieces 34 and the fixing extension 11 pulls the tensioner pieces 34 even more in the direction of the opening 22, which on being pushed up against the conical shell shaped internal surface of the base body 31, clamp the fixing extension 11 even more, and so it cannot be pulled out of the opening 22 of the housing 20. It should be noted here that this operation of the clamping part-unit 30 forms a part of the state of the art, the given request for protection is not aimed at this locking mechanism.

After the customer has purchased the clothing product then the authorised person, such as the cashier, brings the shifting part-unit 50 into operation by using the propulsion device 1 and the unlocking device 2. In the case of using the unlocking device 2, the unlocking device 2 shifts the bolt body 3 against the return piece 4, or actually with its help, along the movement axis 3a in such a way that the bolt body 3 leaves the second bolt-accommodating cavity 54 of the shifting part-unit 50. Following this using the propulsion device 1, the torque transferred to the movement receipt body 53 induces the moving piece 51 of the shifting part-unit 50 to rotate in such a way that it rotates around the longitudinal axis 31a of the base body 31 and simultaneously around the rotation axis 52 or the shifting part-unit 50 from left to right, as viewed in FIG. 1, in the anticlockwise direction.

In the course of this rotation of the moving piece 51, the first sliding surface 51a of the moving piece 51 forming a screw thread path running along a helix slides along the stationary supporting surface 23 also forming a screw thread path running along a helix formed on the stationary base body 31. The moving piece 51 rotating in the course of the sliding does not only rotate around the rotation axis 52 due to the structure of the first sliding surface 51a-stationary supporting surface 23, instead, as also seen in FIG. 1, it also rises as compared to the opening 22 of the housing 20, along the spiral path created by the stationary supporting surface 23.

However, the second sliding surface 51b of the rising moving piece 51 comes into contact with moving supporting surface 33d of the holding piece 33, and in this way the holding piece 33 also starts to rise in the direction of the longitudinal axis 31a of the base body 31. While the holding piece 33 rises out of the holding space 32 enclosed by the base body 31, on the one part it pushes together the coil spring used as returning element 40 interposed between the housing 20 and the holding piece 33, in which strain energy is accumulated. On the other part, the tensioner pieces 34 located at the internal end 33a of the holding piece 33 also start to rise, and move away from the opening 22 of the housing 20.

While the tensioner pieces 34 are being lifted out they get to an increasingly larger cross-section part of the conical shell shaped surface delimiting the holding space 32, and in this way the tensioning effect on the fixing extension 11 derived from the conical surface weakens, and finally ceases to exist, as the tensioner pieces 34 will have sufficient space to move away from the fixing extension 11 in the lateral direction. In this case it becomes easy to pull out the fixing extension 11 through the opening 22 of the housing 20 from among the released tensioner pieces 34 from the holding space 32 enclosed by the base body 31 of the housing 20.

After the fixing extension 11 of the head part 10 has been removed, the propulsion device 1 and the unlocking device 2 may be removed from the goods protection label. Then after the termination of the torque exerted onto the movement receipt body 53 the strain energy accumulated in the returning element 40 pushes the holding piece 33 back into its basic position. During the movement of the holding piece 33 it pushes the second sliding surface 51b of the moving piece 51 downwards via the moving supporting surface 33d. As a consequence of the force exerted onto the second sliding surface 51b the first sliding surface 51a of the moving piece 51 now starts to slide in the other direction on the stationary supporting surface 23 of the base body 31 of the housing 20. As a result of this the moving piece 51 rotates around the rotation axis 52 in the clockwise direction from right to left, while it descends on the stationary supporting surface 23. Due to the moving piece 51 descending the holding piece 33 also descends back into the holding space 32 of the base body 31, where the tensioner pieces 34 once against get into a “tighter” position and now being closer to each other wait for the next introduction of the fixing extension 11 of the head part 10.

While the moving piece 51 is rotating back the second bolt-accommodating cavity 54 of the shifting part-unit 50 once again turns to be in front of the first bolt-accommodating cavity 24 of the housing 20. In this case the bolt body 3 once again penetrates against the return piece 4 into the second bolt-accommodating cavity 54 as well, and in this way locks the moving piece 51 that has returned to its basic position with the housing 20 thereby preventing the moving piece 51 from rotating.

In the case of placing the goods protection label onto a new product, the process disclosed previously is performed once again, both in the case of securing the fixing extension 11 of the head part 10, and in the case of pulling out the fixing extension 11 of the head part 10.

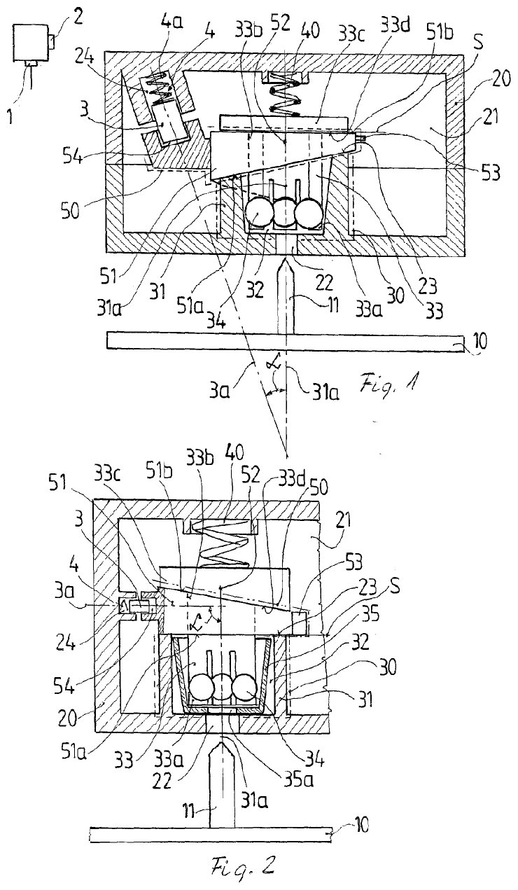

Moving over now to FIG. 2, a goods protection label is shown that may be preferably used in the case of textile goods purchased by the metre. Here also the head part 10 having the fixing extension 11 and the housing 20 provided with the clamping part-unit 30 and shifting part-unit 50 may be found. However, the fundamental difference is that here a truncated cone shell shaped insert 35 made from metal is inserted into the holding space 32 delimited by the base body 31 penetrating into the receiving space 21 of the housing 20. A guide passage 35a is located on the insert 35 in such a way that it substantially coincides with the opening 22 of the housing 20.

In the case of this version of the goods protection label the holding piece 33 is released into the insert 35 in such a way that the internal end 33a of the holding piece 33 and the tensioner pieces 34 located there are positioned close to both the guide passage 35a of the insert 35 and to the opening 22 of the housing 20.

The other important difference as compared to the structure of the goods protection label presented in FIG. 1 is that here the first sliding surface 51a of the moving piece 51 of the shifting part-unit 50 facing the stationary supporting surface 23 formed on the base body 31 of the housing 20, and the stationary supporting surface cooperating with it are located each in a plane “S”, which is perpendicular to the longitudinal axis 31a of the base body 31, and the rotation axis 52 of the shifting part-unit 50. While the second sliding surface 51b, and the moving supporting surface 33d located on the encircling collar 33c formed at the external end 33b of the holding piece 33 each form a screw thread path on a helix at least partially running around the rotation axis 52 of the shifting part-unit 50.

The movement receipt body 53 protruding from the moving piece 51, and the second bolt-accommodation cavity 54 may also be found here. Also the housing 20 has a first bolt-accommodation cavity 24 and bolt body 3 placed in it. Here too the bolt body is capable of moving along the movement axis 3a. The return piece 4 is also inserted into the first bolt-accommodation cavity 24, between the bolt body 3 and the housing 20. However, in the case of the given embodiment the first bolt-accommodation cavity 24 and the second bolt-accommodation cavity 54 are formed so that the movement axis 3a of the bolt body 3 placed in it is at an tilt angle “a” of 90° to the longitudinal axis 31a of the base body 31 and also to the rotation axis 52 of the moving piece 51.

The operation of the goods protection label according to FIG. 2 is essentially the same as the operation of the goods protection label shown in FIG. 1. When receiving the fixing extension 11 of the head part 10, the fixing extension 11 guided through the opening 22 of the housing 20 also passes through the guide passage 35a of the insert 35, and only following this does it get into the part of the holding space 32 of the base body 31 where the holding piece 33 and the group of tensioner pieces 34 are.

Here in the case of pulling the fixing extension 11 penetrated among the tensioner pieces 34 of the clamping part-unit 30 outwards the tensioner pieces 34 are forced up against the conical shell of the metal insert 35, and in this way create the vice-like clamping on me fixing extension 11. The use of the insert 35 is preferable because in this way the tensioning force occurring when pulling out the fixing extension 11 appears on harder material. This may increase the lifetime of the goods protection label and also the reliability of the securing.

When releasing the fixing extension 11, after moving the bolt body 3 and releasing the rotation possibility of the moving piece 51, the torque exerted onto the movement receipt body 53 also rotates the moving piece 51, but in this case the moving piece 51 itself does not rise as compared to the opening 22 of the base body 31 of the housing 20. In this embodiment the first sliding surface 51a of the moving piece 51 only slide on the stationary supporting surface 23 when turned. However, the second sliding surface 51b, as a result of its structure, when rotating around the rotation axis 52, and while sliding on the moving supporting surface 33d lifts the holding piece 33 along with the encircling collar 33c. As a consequence of the cooperation of the second sliding surface 51b-moving supporting surface 33d, if the second sliding surface 51b rotates around the rotation axis 52, then the screw thread path lifts the collar 33c encircling the holding piece 33. Here too the magnitude of the cross-section perpendicular to the longitudinal axis 31a and enclosed by the insert 35 increases at the internal end 33a of the holding piece 33 rising out of the holding space 32 of the base body 31. So as a consequence of this the movement of the tensioner pieces 34 is released and they make it possible for the fixing extension 11 to be pulled out in the direction of the longitudinal axis 31a of the base body 31 through the guide passage 35a and the opening 22 from the receiving space 21 of the housing 20.

On the basis of the presented examples it can be seen that the first sliding surface 51a and the second sliding surface 51b of the moving piece 51 of the shifting part-unit 50, as well as the stationary supporting surface 23 of the housing 20 and the moving supporting surface 33d of the holding piece 33 may be formed in several ways. A version is conceivable, for example, where both the first sliding surface 51a-stationary supporting surface 23, and the second sliding surface 51b-moving supporting surface 33d pairs are formed by encircling screw thread paths. In this case the holding piece 33 may move as much in the direction of the longitudinal axis 31a during a shorter angular rotation of the moving piece 51 that is permitted by the tensioner pieces 34 clamping the fixing extension 11.

It should be noted here that the movement-preventing structural part consisting of the first bolt-accommodating cavity 24 of the housing 20, the second bolt-accommodating cavity 54 of the shifting part-unit 50, and the bolt bodies 3 placed in them has an important security role in the operation of the goods protection label.

It is also obvious that the angle between the movement axis 3a of the bolt body 3 and the rotation axis 52 of the moving piece 51 of the shifting part-unit 50 may have any value between 0-90°, including 0° and 90° also. The important aspect here is that the bolt body 3 prevents the turning, moving of the moving piece 51 in the opening direction.

Moving over to FIG. 3, this shows a yet another different embodiment of the goods protection label according to the invention. It may be observed that here too the tensioner pieces 34 may be found at the internal end 33a of the holding piece 33 protruding into the insert 35 fitted into the holding space 32 of the base body 31 established in the receiving space 21 of the housing and forming a part of the clamping part-unit 30. Here also the housing 20 has an opening 22, and the guide passage 35a also may be found in the insert 35. The fixing extension 11 of the head part 10 may be pushed through the opening 22 and the guide passage 35a among the tensioner pieces 34 of the holding piece 33.

Here however the moving piece 51 of the shifting part-unit 50 is made from a single piece of material directly with the external end 33b of the holding piece 33, preferably by injection moulding. Here the first sliding surface 51a of the moving piece 51 is in direct contact with the stationary supporting surface 23 of the base body 31 of the housing 20. Optionally the stationary supporting surface 23 and the first sliding surface 51a cooperate together to constitute a saw tooth-like multi-start screw thread path forming a rising inclined path that at least partially runs around the rotation axis 52 of the shifting part-unit 50.

The moving piece 51 of the shifting part-unit 50 also has a movement receipt body 53, which is periodically, when the goods protection label is opened, in contact with the propulsion device 1, which forces the moving piece 51 to rotate around the rotation axis 52 of the shifting part-unit 50.

The moving piece 51 of the shifting part-unit 50 also contains the second bolt-accommodating cavity 54, which along with the first bolt-accommodating cavity 24 of the housing 20 receives the bolt body 3. The return piece 4 is located between the bolt body 3 and the housing 20 in the first bolt-accommodating cavity 24, the task of which here too is to push the bolt body 3, in basic position, in the direction of the second bolt-accommodating cavity 54 of the moving piece 51 of the shifting part-unit 50 and thereby to prevent the rotation of the moving piece 51.

In the case of this version the movement axis 3a of the bolt body 3 is parallel with the rotation axis 52 of the shifting part-unit 50, i.e. the tilt angle “a” between the movement axis 3a and the rotation axis 52 is 0°, which is obviously not indicated in the figure.

During the operation of the goods protection label according to FIG. 3 the securing of the fixing extension 11 of the head part 10 to the housing 20 is the same as that disclosed in the case of FIG. 1. Here too the clamping of the fixing extension 11 of the head part 10 takes place with the tensioner pieces 34 located in the holding piece 33.

In the case that the fixing extension 11 of the head part 10 is released, first of all the unlocking device 2 must be used to release the blocking of the bolt body 3 implementing the securing between the housing 20 and the moving piece 51.

Subsequently, the unlocking device 2 conveys torque to the movement receipt body 53 of the moving piece 51 of the shifting part-unit 50. As a result of the effect of the torque the moving piece 51 rotates around the rotation axis 52, and as a consequence of the cooperation between the tooth-like wedge paths of the stationary support surface 23 and the first sliding surface 51a fitting into each other, the moving piece 51 lifts up in the course of its rotational sliding from the opening 22 of the housing 20, while compressing the returning element 40 interposed between the housing 20 and the moving piece 51.

As the moving piece 51 and the holding piece 33 constitute a single unit, therefore the internal end 33a of the holding piece 33 also starts to lift up while rotating around the rotation axis 52 and moves away from the opening 22 of the housing 20 and the guide passage 35a of the insert 35.

In such a case the lateral support of the tensioner pieces 34 ceases due to the increasing diameter of the conical shell shape of the internal surface of the insert 35 in the upwards direction, and the tensioner pieces 34 “release” the fixing extension 11 of the head part 10, which then can be pulled out of the holding space 32 of the base body 31 of the housing 20.

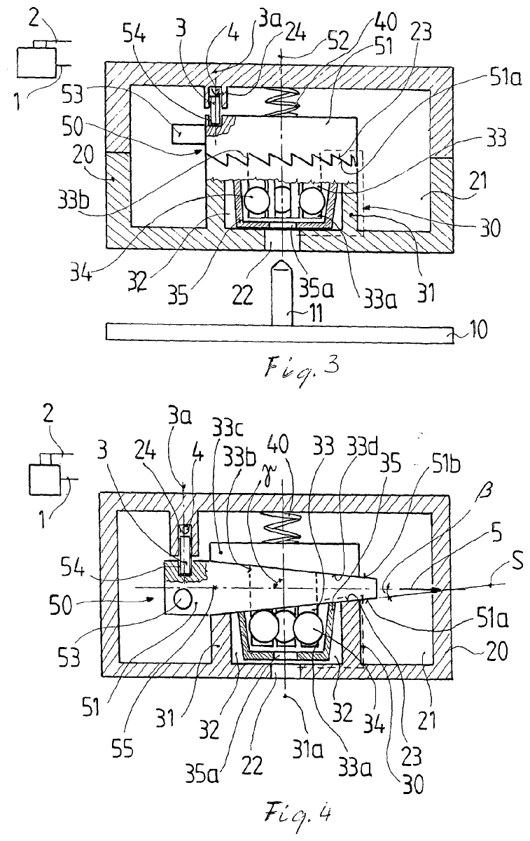

Moving over now to FIG. 4, this shows another version of the goods protection label according to the invention. It may be observed that the base body 31 may be found in the case of this version also, which is located in the receiving space 21 of the housing 20, is made from the material of the housing 20 and belongs to the clamping part-unit 30, and the metal insert 35 is located in its holding space 32. Here too the housing 20 has an opening 22, which coincides with the guide passage 35a of the insert 35.

Also present is the holding piece 33, which protrudes into the insert 35, at the internal end 33a of which the tensioner pieces 34 may be found. Here too the external end 33b of the holding piece 33 is provided with an encircling collar 33c, that has a moving supporting surface 33d facing the base body 31. Then the stationary supporting surface 23 may be found on the side of the base body 31 facing the encircling collar 33c of the holding piece 33. The returning element 40 is present here too between the encircling collar 33c of the holding piece 33 and the housing 20, which constantly forces the holding piece 33 in the direction of the guide passage 35a of the insert 35.

Here too the moving piece 51 of the shifting part-unit 50 is interposed between the stationary supporting surface 23 of the base body 31 and the encircling collar 33c of the holding piece 33, which here, however, differs from the previously presented versions in terms of both geometrical structure and operation. As here the first sliding surface 51a of the moving piece 51 facing the stationary supporting surface 23 and the second sliding surface 51b facing towards the moving supporting surface 33d of the holding piece 33 constitute a planar surface, the plane “S” of which is inclined an acute angle of inclination “β” to the plane that is perpendicular to the longitudinal axis 31a of the base body 31 and contains the longitudinal main axis 55 of the shifting part-unit 50. In the case of the given version both the first sliding surface 51a-stationary supporting surface 23, and the second sliding surface 51b-moving supporting surface 33d are planar surfaces inclined as compared to the longitudinal axis 31a of the base body 31. The advantage of this is that a smaller movement of the moving piece 51 induces a large movement between the stationary supporting surface 23 of the base body 31 and the moving supporting surface 33d of the holding piece 33. But here it must be noted that an embodiment is conceivable in the case of which only either the stationary supporting surface 23—first sliding surface 51a surface pair or the moving supporting surface 33d-second sliding surface 51b surface pair has an inclined planar surface, while the other surface pair is in the plane “S” perpendicular to the longitudinal axis 31a of the base body 31.

FIG. 3 also shows that this embodiment also includes the movement receipt body 53 and the second bolt-accommodating cavity 54 on the moving piece 51 of the shifting part-unit 50. The second bolt-accommodation cavity 54 receives the bolt body 3 together with the first bolt-accommodating cavity 24 of the housing 20. The return piece 4 maintains the bolt body 3 in basic position in such a way that a part of the bolt body 3 protrudes from the first bolt-accommodating cavity 24 into the second bolt-accommodating cavity 54.

When the goods protection label according to FIG. 3 operates, there is only a difference in the removal of the goods protection label in the operation of the shifting part-unit 50 as compared to that disclosed previously. Here too firstly the locking of the bolt body 3 must be disabled with the use of the unlocking device 2. Following this by using the propulsion device 1 and the movement energy passed on to the moving piece 51 via the movement receipt body 53 the moving piece 51 can be moved in the sliding direction 5. Here the sliding direction 5 is at an angle “γ” of 90° to the longitudinal axis 31a of the base body 31, and in this way the first sliding surface 51a of the moving piece 51 slides perpendicular to the longitudinal axis 31a on the stationary supporting surface 23 of the base body 31, while the second sliding surface 51b of the moving piece 51 slides along the moving supporting surface 33d of the holding piece 33.

While the moving piece 51 slides in the sliding direction 5 from left to right as viewed in FIG. 3, due to the effect of the dual wedge path the moving supporting surface 33d of the encircling collar 33c of the holding piece 33 lifts up as compared to the stationary supporting surface 23 of the base body 31. Due to this the internal end 33a of the holding piece 33 stalls to move away from the guide passage 35a of the insert 35 and as the tensioner pieces 34 get into the wider cross-sectional part of the insert 35 they are able to release the fixing extension 11 of the head part 10 from their grip—not shown in FIG. 3. In this way it becomes possible to pull out the fixing extension 11 through the guide passage 35a of the insert 35 and the opening 22 of the housing 20 from the interior of the insert 35 located in the holding space 32 enclosed by the base body 31.

It should be noted here that optionally although the movement axis 3a of the bolt body 3 is at an tilt angle “α” of 0° to the longitudinal axis 31a of the base body 31, it is perpendicular to the sliding direction 5 falling in the longitudinal main axis 55 of the moving piece 51 of the shifting part-unit 50. In this way the bolt body 3 provides suitable locking against the sliding of the moving piece 51 of the shifting part-unit 50.

### Interpretation

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Description of Preferred Embodiments are hereby expressly incorporated into this Description of Preferred Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

The terms in the claims have the broadest scope of meaning they would have been given by a person of ordinary skill in the art as of the relevant date.

The terms “a” and “an” mean “one or more”, unless expressly specified otherwise.

Neither the title nor any abstract of the present application should be taken as limiting in any way the scope of the claimed invention.

Where the preamble of a claim recites a purpose, benefit or possible use of the claimed invention, it does not limit the claimed invention to having only that purpose, benefit or possible use.

In the present specification, terms such as “part”, “component”, “means”, “section”, or “segment” may refer to singular or plural items and are terms intended to refer to a set of properties, functions or characteristics performed by one or more items having one or more parts. It is envisaged that where a “part”, “component”, “means”, “section”, “segment”, or similar term is described as consisting of a single item, then a functionally equivalent object consisting of multiple items is considered to fall within the scope of the term; and similarly, where a “part”, “component”, “means”, “section”, “segment”, or similar term is described as consisting of multiple items, a functionally equivalent object consisting of a single item is considered to fall within the scope of the term. The intended interpretation of such terms described in this paragraph should apply unless the contrary is expressly stated or the context requires otherwise

The term “connected” or a similar term, should not be interpreted as being limitative to direct connections only. Thus, the scope of the expression an item A connected to an item B should not be limited to items or systems wherein an output of item A is directly connected to an input of item B. It means that there exists a path between an output of A and an input of B which may be a path including other items or means. “Connected”, or a similar term, may mean that two or more elements are either in direct physical, magnetic and/or electrical contact, or that two or more elements are not in direct contact with each other yet still co-operate or interact with each other.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention.

### INDUSTRIAL APPLICABILITY

The goods protection label according to the invention may be used to good effect in the case of all products to be protected where it is permitted to pierce the material of the product with the fixing extension of the head part, and there is a need for a reliably operating protective device that is difficult to sabotage.

1. A goods protection label that is able to be secured to a product, the goods protection label including:
a head part having a fixing extension,
a housing adapted for accommodating the fixing extension of the head part, and
a clamping part-unit for receiving at least a part of the fixing extension is located in a receiving space of the housing, the clamping part-unit having a base body surrounding a holding space, a holding piece and at least two moveable tensioner pieces fitted into the holding piece,
where
the housing has an opening in the vicinity of the clamping part-unit adapted for transferring the fixing extension,
a returning element capable of flexibly changing shape is interposed between the holding piece and the housing, the returning element being configured to force the holding piece and/or the tensioner pieces in the direction of the opening located in the vicinity of the clamping part-unit,
the holding piece is coupled with a shifting part-unit, and the shifting part-unit is interposed between the holding piece and the housing adapted for removing an internal end of the holding piece supporting the tensioner pieces from the opening of the housing,
the shifting part-unit has a moving piece,
the moving piece has a first sliding surface and a second sliding surface,
the housing has a stationary supporting surface in contact with the first sliding surface of the moving piece, and the holding piece has a moving supporting surface in contact with the second sliding surface of the moving piece,
where the first sliding surface and the stationary supporting surface and/or the second sliding surface and the moving supporting surface cooperate with each other to provide rotation of the moving piece around a rotation axis of the shifting part-unit, and
the moving piece of the shifting part-unit is interposed between the stationary supporting surface of the housing and the moving supporting surface of the holding piece in such a way that it is able to rotate around the rotation axis of the shifting part-unit,
wherein:
the goods protection label includes a movement-preventing structural part to prevent rotation of the moving piece, the movement-preventing structural part able to be unlocked by use of an unlocking device,
the moving piece of the shifting part-unit is provided with a movement receipt body that is connectable to a propulsion device for applying torque to the movement receipt body to rotate the moving piece, and
the head part of the goods protection label is able to be removed from the housing by:
use of the unlocking device to release the movement-preventing structural part to permit movement of the moving piece, and then
use of the propulsion device to rotate the moving piece.

2. The goods protection label according to claim 1, wherein the first sliding surface and the stationary supporting surface and/or the second sliding surface and the moving supporting surface are formed by screw thread paths cooperating with each other located along a helix at least partially running around the rotation axis of the shifting part-unit.

3. A goods protection label according to claim 1, wherein the first sliding surface and the stationary supporting surface and/or the second sliding surface and the moving supporting surface are screw thread paths cooperating with each other forming a saw tooth-like multi-start rising inclined track at least partially running around the rotation axis of the shifting part-unit.

4. The goods protection label according to claim 1, wherein the first sliding surface of the moving piece slides perpendicular to a longitudinal axis on the stationary supporting surface of the base body.

5. The goods protection label according to claim 1, wherein the rotation axis of the shifting part-unit is perpendicular to the longitudinal axis of the base body.

6. The goods protection label according to claim 4, wherein the torque transferred by the propulsion device to the movement receipt body induces the moving piece of the shifting part-unit to rotate in such a way that it rotates around the longitudinal axis of the base body and simultaneously around the rotation axis of the shifting part-unit.

7. The goods protection label according to claim 6, wherein the head part may be removable from the housing by using a propulsion device that is independent of the unlocking device.

8. The goods protection label according to claim 1, wherein the movement axis of the movement-preventing body is at a tilt angle to the rotation axis of the moving piece of the shifting part-unit having a value between 0-90°, including 0° and 90°.

9. The goods protection label according to claim 1, wherein the holding piece at least partially protrudes into the holding space of the base body.

10. The goods protection label according to claim 1, wherein lifting up the holding piece and/or tensioner pieces enables the fixing extension to be removed through the opening of the housing from among the released tensioner pieces from the holding space enclosed by the base body of the housing.

11. The goods protection label according to claim 1, wherein the movement preventing-structural part includes a first cavity in the housing and movement of the moving piece is allowed when the movement-preventing body occupies the first cavity.

12. The goods protection label according to claim 11, wherein the movement-preventing structural part includes a movement-preventing body and a second cavity in the shifting part-unit, such that movement of the moving piece is prevented when the movement-preventing body occupies the second cavity.

13. The goods protection label according to claim 1, wherein the housing is provided with a first bolt-accommodating cavity, while the moving piece of the shifting part-unit is provided with a second bolt-accommodating cavity, and the first bolt-accommodating cavity and the second bolt-accommodating cavity are coupled with the bolt body for cooperating with them, where the bolt body is fitted into the first bolt-accommodating cavity of the housing with the interposition of a return piece so as to protrude from it but is capable of being moved back into it, and the movement axis of the bolt body is at an tilt angle of between 0-90° to the longitudinal axis of the base body.

14. The goods protection label according to claim 13, wherein an insert made from a metal material is inserted into the holding space of the base body, and the holding piece of the clamping part-unit is at least partially inserted into the insert.

15. The goods protection label according to claim 13, wherein the insert is also provided with a guide passage adapted for transferring the fixing extension, and the guide passage of the insert is located in the vicinity of the opening of the housing.

16. The goods protection label according to claim 1, wherein the fixing extension is extendible.

17. A goods protection label that is able to be secured to a product, the goods protection label including:
a head part having an extendible fixing extension,
a housing adapted for accommodating the extendible fixing extension of the head part, and
a clamping part-unit for receiving at least a part of the fixing extension, the clamping part-unit being located in a receiving space of the housing, the clamping part-unit having a base body surrounding a holding space, as well as holding piece at least partially protruding into the holding space of the base body and at least two moveable tensioner pieces fitted into the holding piece,
where
the housing has an opening in the vicinity of the clamping part-unit adapted for transferring the fixing extension,
a returning element capable of flexibly changing shape is interposed between the holding piece and the housing, the returning element being configured to force the holding piece and/or the tensioner piece in the direction of the opening located in the vicinity of the clamping part-unit,
the holding piece is coupled with a shifting part-unit, and the shifting part-unit is interposed between the holding piece and the housing adapted for removing an internal end of the holding piece supporting the tensioner pieces from the opening of the housing,
the shifting part-unit has a moving piece having a sliding surface,
the housing has a stationary supporting surface in contact with the sliding surface of the moving piece,
where the sliding surface and the stationary supporting surface are formed by screw thread paths cooperating with each other located along a helix at least partially running around a rotation axis of the shifting part-unit, and
the moving piece of the shifting part-unit is interposed between the stationary supporting surface of the housing and an external end of the holding piece in such a way that it is able to rotate around the rotation axis of the shifting part-unit,
Wherein:
the goods protection label includes a movement-preventing structural part to prevent rotation of the moving piece, the movement-preventing structural part able to be unlocked by use of an unlocking device,
the moving piece of the shifting part-unit is provided with a movement receipt body that is able to be connected to a propulsion device for applying torque to the movement receipt body to rotate the moving piece, and
the head part of the goods protection label is able to be removed from the housing by:
use of the unlocking device to release the movement-preventing structural part to permit movement of the moving piece, and then
use of the propulsion device to rotate the moving piece.

18. A goods protection label according to claim 17, wherein the holding piece of the clamping part-unit and the moving piece of the shifting part-unit are from a single piece, and the sliding surface is formed on the side of the moving piece formed as an encircling collar at the external end of the holding piece facing the base body of the clamping part-unit.

19. A goods protection label according to claim 18, characterised by that the sliding surface and the stationary supporting surface are screw thread paths cooperating with each other forming a saw tooth-like multi-start rising inclined track at least partially running around the rotation axis of the shifting part-unit.

20. A goods protection label that is able to be secured to a product, the goods protection label including:
a head part having an extendible fixing extension; and
a housing adapted for accommodating the extendible fixing extension of the head part,
a clamping part-unit for receiving at least a part of the fixing extension is located in a receiving space of the housing, the clamping part-unit having a base body surrounding a holding space, as well as a holding piece at least partially protruding into the holding space of the base body and at least two moveable tensioner pieces fitted into the holding piece,
where
the housing has an opening in the vicinity of the clamping part-unit adapted for transferring the fixing extension,
a returning element capable of flexibly changing shape is interposed between the holding piece and the housing, the returning element being configured to force the holding piece and/or the tensioner pieces in the direction of the opening located in the vicinity of the clamping part-unit,
the holding piece is coupled with a shifting part-unit, and the shifting part-unit is interposed between the holding piece and the housing adapted for removing an internal end of the holding piece supporting the tensioner pieces from the opening of the housing,
the shifting part-unit has a moving piece,
the moving piece has a first sliding surface and a second sliding surface, the housing has a stationary supporting surface in contact with the first sliding surface of the moving piece, and the holding piece has a moving supporting surface in contact with the second sliding surface of the moving piece,
where the first sliding surface and the stationary supporting surface and/or the second sliding surface and the moving supporting surface are formed by wedge path strips located in a plane at an acute angle of inclination to a longitudinal main axis of the shifting part-unit, and
the moving piece of the shifting part-unit is interposed between the stationary supporting surface of the housing and the moving supporting surface of the holding piece in such a way that it is able to slide in a sliding direction at an angle of 60-120° to the longitudinal main axis of the shifting part-unit,
wherein:
the goods protection label includes a movement-preventing structural part to prevent movement of the moving piece, the movement-preventing structural part able to be unlocked by use of an unlocking device,
the moving piece of the shifting part-unit is provided with a movement receipt body that is able to be connected to a propulsion device for applying moving the moving piece in the sliding direction, and
the head part of the goods protection label is able to be removed from the housing by:
use of the unlocking device to release the movement-preventing structural part to permit movement of the moving piece, and then
use of the propulsion device to move the moving piece.
